(19) United States
(12) Patent Application Publication
(10) Pub. No.: US 2006/0227960 A1
(43) Pub. Date: Oct. 12, 2006

(54) Method, system and program product for providing directory assistance services

(76) Inventor: Daniel A. Hanson, Dallas, TX (US)

Correspondence Address: DILLON & YUDELL LLP, 8911 NORTH CAPITAL OF TEXAS HWY, SUITE 2110, AUSTIN, TX, 78759, US

(21) Appl. No.: 11/329,772

(22) Filed: Jan. 11, 2006

Related U.S. Application Data
(60) Provisional application No. 60/672,645, filed on Apr. 8, 2005.

(51) Int. Cl. H04M 7/00; H04M 3/00

(52) U.S. Cl. 379/230; 379/221.08; 379/308; 379/320; 379/377

(57) ABSTRACT

A communication network includes a serving switch that receives a directory assistance call. In response to receipt of the directory assistance call, the serving switch signals, via an out-of-band signaling link, to initiate reservation of a call path for the directory assistance call in a telephony network, where the call path includes a circuit loop at the serving switch. In response to reservation of the call path, the serving switch establishing a voice connection via the reserved call path in the telephony network to permit provision of directory assistance services.

### PRIORITY CLAIM AND CROSS-REFERENCE

The present application claims priority to U.S. Provisional Patent Application 60/672,645, which is incorporated herein by reference in its entirety.

### BACKGROUND OF THE INVENTION

1. Technical Field

The present invention relates in general to telecommunication and in particular to the provision of services, such as directory assistance and call completion, in a telephone network.

2. Description of the Related Art

Conventionally, telephone companies have offered directory assistance services that provide a caller with the telephone number of a telephone customer. Typically, the caller initiates a directory assistance call by dialing a specified telephone number (e.g., NPA-555-1212, 1411, 411, or 101xxxx). The directory assistance operator or automated directory assistance system answering the directory assistance call may first request that the caller provide the locality of the customer for which a listing is desired. If listings for the requested locality are not maintained by that directory assistance center, the caller may be referred to a different directory assistance telephone number handling listings for the requested locality. If, on the other hand, the directory assistance center contacted by the caller handles listings for the requested locality, the directory assistance operator or automated directory assistance system searches the directory database for a listing corresponding the customer, and if the customer's telephone number is contained in the database and is not unlisted, provides the customer's number to the caller, typically in an audio announcement.

Formerly, the caller would have to write down (or memorize) the customer's telephone number, hang up, again go off-hook, and then dial the telephone customer's number. This procedure is inconvenient to the caller and can even be dangerous in certain situations, for example, if the caller is making the directory assistance call from a wireless telephone in a moving automobile. Thus, in order to provide enhanced directory assistance service to callers, the directory assistance centers serving many telephone companies offer the caller the option of having the directory assistance center complete a call to the customer automatically, often for a nominal fee. If the caller requests that the call be completed automatically, for example, by dialing “1”, the directory assistance center conventionally originates a second call to the requested telephone number via the switch through which the directory assistance center is coupled to the public telephone network.

Conventional directory assistance services, including call completion services, are expensive to provide. A large operating cost for conventional directory assistance centers is the expense of the voice channels (often dedicated) used to communicate between the directory assistance center and the serving switch(es) of the telephone network. The expense associated with automatic call completion can be even higher than for directory assistance in that automatic call completion can consume two voice channels—one for the directory assistance call and a second for the call originated by the directory assistance center.

### SUMMARY OF THE INVENTION

In view of the foregoing, the present invention provides an improved method, system and program product for providing telephony services, such as directory assistance and call completion.

According to one embodiment, a communication network includes a serving switch that receives a directory assistance call. In response to receipt of the directory assistance call, the serving switch signals, via an out-of-band signaling link, to initiate reservation of a call path for the directory assistance call in a telephony network, where the call path includes a circuit loop at the serving switch. In response to reservation of the call path, the serving switch establishing a voice connection via the reserved call path in the telephony network to permit provision of directory assistance services.

All objects, features, and advantages of the present invention will become apparent in the following detailed written description.

### BRIEF DESCRIPTION OF THE DRAWINGS

The novel features believed characteristic of the invention are set forth in the appended claims. However, the invention, as well as a preferred mode of use, will best be understood by reference to the following detailed description of an illustrative embodiment when read in conjunction with the accompanying drawings, wherein:

FIG. 1 is a high level block diagram of a communication network in which the present invention may advantageously be employed;

FIG. 2 is a time-space diagram of an exemplary directory assistance call flow in accordance with the present invention; and

FIG. 3 is a time-space diagram of an exemplary call flow including directory assistance call completion in accordance with the present invention.

### DETAILED DESCRIPTION OF ILLUSTRATIVE EMBODIMENT

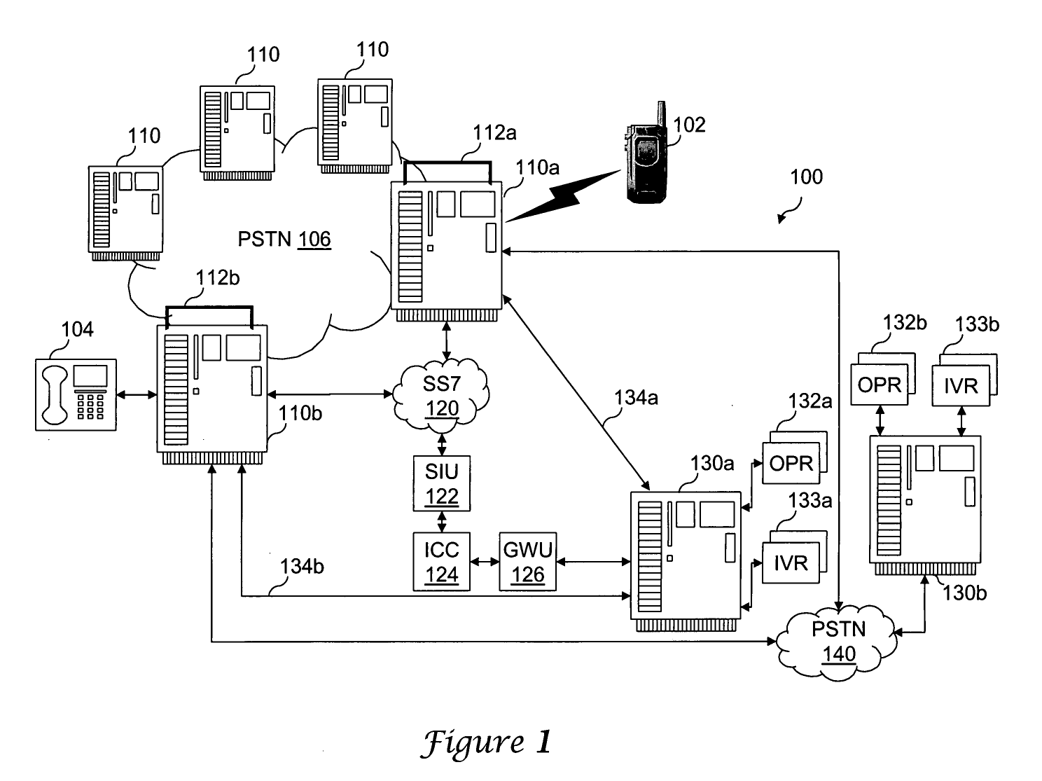

With reference to the figures and in particular with reference to FIG. 1, there is illustrated a high level block diagram of a communication network 100 in which the present invention may advantageously be implemented.

As shown, communication network 100 includes a Public Switched Telephone Network (PSTN) 102 that supports voice and/or data communication between calling stations, such as calling station 102, and called stations, such as called station 104. As will be appreciated, calling station 102 and called station 104 may be any type of device capable of communication over PSTN 106, including a telephone, a mobile, a computer, or other communication device. PSTN 106 includes a plurality of switches 110, including switches 110a and 110b, which respectively serve calling station 102 and called station 104. Each of switches 110a, 110b has a plurality of (i.e., at least 4) trunk connections and is configured with two of its trunk connections interconnected by a physical T1 circuit loop (referred to as an ISDN (Integrated Services Digital Network) User Part (ISUP) loopback) 112 in order to support the innovative methods of directory assistance and call completion discussed below. As will become apparent, switches 110a, 110b may be entirely conventional, except for ISUP loopback 112 and the call control described below, which may be implemented within switches 110a, 100b by hardware and/or program code.

Switches 110 of PSTN 106 are coupled to a Common Channel Signaling System No. 7 (SS7) network 120. As is well known in the art, SS7 network 120 is a digital signaling network that implements procedures and protocols defined by the International Telecommunication Union (ITU) Telecommunication Standardization Sector (ITU-T) to permit network elements in PSTN 106 to perform functions such as call setup, call routing and call control. The signaling over SS7 network 120 is all out-of-band, and accordingly does not consume voice circuits.

Communication network 100 also includes infrastructure to provide directory assistance and call completion services to callers on PSTN 106. The directory assistance infrastructure, which is often owned and operated by a directory assistance provider separate from the entity or entities that own and/or operate PSTN 106, includes a primary directory assistance switch 130a. Primary directory assistance switch 130a supports a primary operator center 132a, which includes a plurality of operator stations for performing telephone number lookup, and an integrated voice response (IVR) unit 133a, which presents an audio messages containing desired telephone numbers and offers call completion services. Primary directory assistance switch 130a is coupled to SS7 network 120 via a system interface unit (SIU), an interworking call control (ICC) unit 124 and a Gateway Unit (GWU) 126. Primary directory assistance switch 130a is also coupled to switches 110a, 110b of PSTN 106 by dedicated T1 lines 134a and 134b, respectively.

To ensure availability of directory assistance and call completion services in the event of power or equipment failure or high traffic levels, the directory assistance infrastructure may optionally further include a backup directory assistance switch 130b, which may be geographically distributed from primary directory assistance switch 130a. Backup directory assistance switch 130b is coupled to switches 110a, 110b by a PSTN 140 (rather than by dedicated T1 lines) and supports a backup operator center 132b and backup IVR unit 133b.

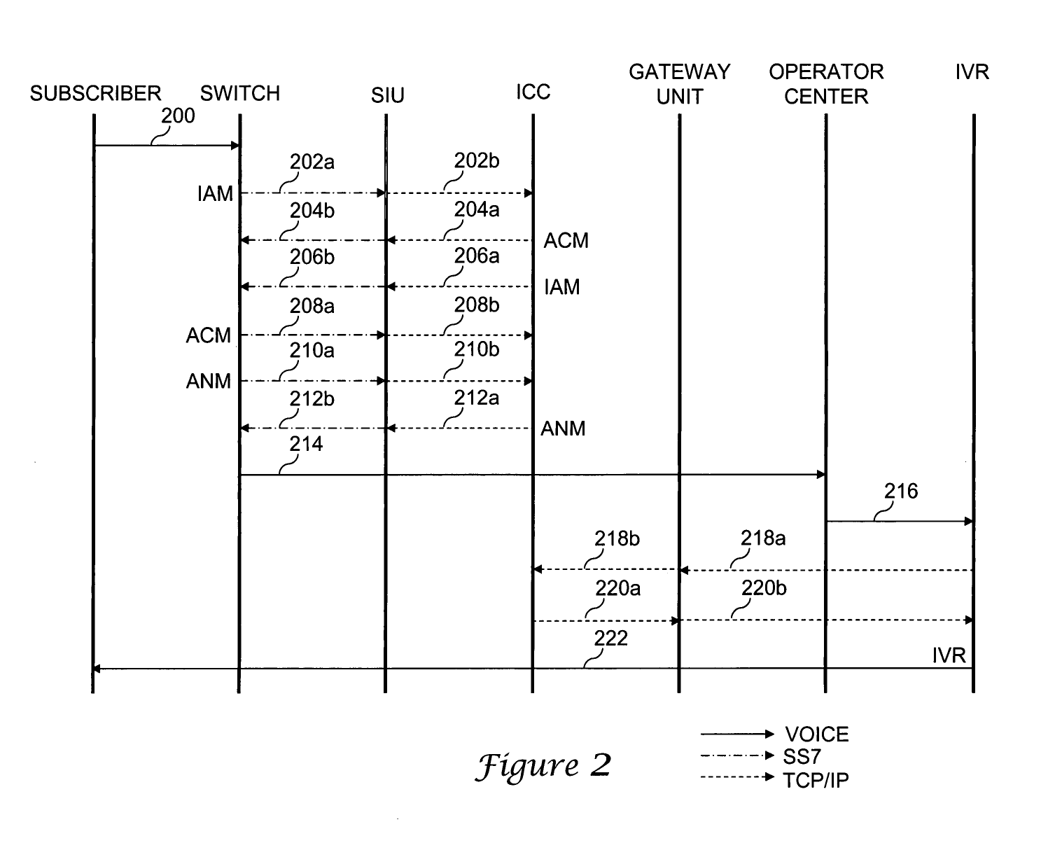

With reference now to FIG. 2, there is illustrated a time-space diagram of an exemplary directory assistance call flow within communication network 100 of FIG. 1 in accordance with the present invention. As depicted, the call flow begins when a subscriber at calling station 102 initiates a directory assistance (DA) call 200 through a serving switch, such as switch 110a. In response to receipt of the DA call, which is recognized by serving switch 110a by its called digits (e.g., NPA-555-1212, 1411, 411, or 101xxxx), serving switch 110a transmits an ISUP Initial Address Message (IAM) 202a to SIU 122 via a Signal Transfer Point (STP) within SS7 network 120 in order to reserve a trunk circuit on ISUP loopback 112a for the directory assistance call. In response to receipt of IAM 202a, SIU 122 converts IAM 202a into an IP IAM 202b and forwards IAM 202b to ICC 124. In response to receipt of IAM 202b, ICC 124 transmits an IP Address Complete Message (ACM) 204a to SIU 122 to indicate that a trunk circuit has been reserved for the DA call. SIU 122 converts ACM 204a into a SS7 ACM 204b and transmits ACM 204b to serving switch 110a.

ICC 124 then instructs serving switch 110a to reserve a trunk circuit for the DA call and to connect the DA call to the operator center 132a by transmitting an IP IAM 206a to SIU 122. In response to receipt of IAM 206a, SIU 122 converts IAM 206a into an SS7 IAM 206b and forwards IAM 206b to serving switch 110a. In response to receipt of IAM 206b, serving switch 110a transmits an SS7 ACM 208a to SIU 122 to indicate that a trunk circuit has been reserved for the DA call. SIU 122 converts SS7 ACM 208a into an IP ACM 208b and sends ACM 208b to ICC 124. As depicted at reference numeral 210a, once the DA call has been answered by primary directory assistance switch 130a, serving switch 110a connects the DA call to the reserved trunk circuit and transmits an SS7 Answer Message (ANM) 210a to SIU 122 to indicate that a trunk circuit has been connected to the DA call. At this point, serving switch 110a also generates a billing record for the DA call. In response to receipt of SS7 ANM 210a, SIU 122 converts ANM 210a into an IP ANM 210b and transmits ANM 210b to ICC 124.

ICC 124 responds to ANM 210b by connecting the DA call to the reserved trunk circuit and creating a record of the call detail. The record of call detail created by ICC 124 can be utilized to automatically generate billing records, for example, in which an independent directory assistance provider bills the telephone carrier operating serving switch 110a for providing directory assistance services. ICC 124 also transmits an IP ANM 212a to SIU 122, which converts ANM 212a into an SS7 ANM 212b and transmits ANM 212b to serving switch 110a. At this point in the call flow, the DA call is connected from the incoming trunk, all the way through serving switch 110a, through ISUP loopback 112a and out to primary directory assistance switch 130a.

In response to receipt of voice call 214, a human or automated operator at operator center 132a looks up the telephone number of called station 204 in a conventional manner. Operator center 132a then transfers the voice call and the requested telephone number to primary IVR unit 133a, as shown at reference numeral 216. Primary IVR unit 133a then sends an IP control query message containing the Automatic Number Identification (ANI) (i.e., the number of the calling station 102) and optionally additional information through gateway unit 126 to ICC 124 via IP, as shown at reference numerals 218a and 218b. IP control query message 218b serves as a query regarding whether DA call 214 originated through an ISUP loopback 110a and can therefore be completed utilizing automatic call completion.

In response to control query message 218b, ICC 124 provides an IP query response 220a, 220b containing either an acknowledgement indicating that DA call 214 originated via an ISUP loopback or a negative acknowledgment indicating that ICC DA call 214 cannot confirm that DA call 214 originated via an ISUP loopback. If IP query response 220b contains an acknowledgement, primary IVR unit 133a plays an audio announcement 222 containing the requested telephone number and offering automatic call completion services (e.g., “press 1 or remain on the line to complete your call . . . ”). If, on the other hand, IP query response 220b contains a negative acknowledgment, primary IVR unit 133a simply plays an audio announcement 222 with the requested number, but does not offer automatic call completion services.

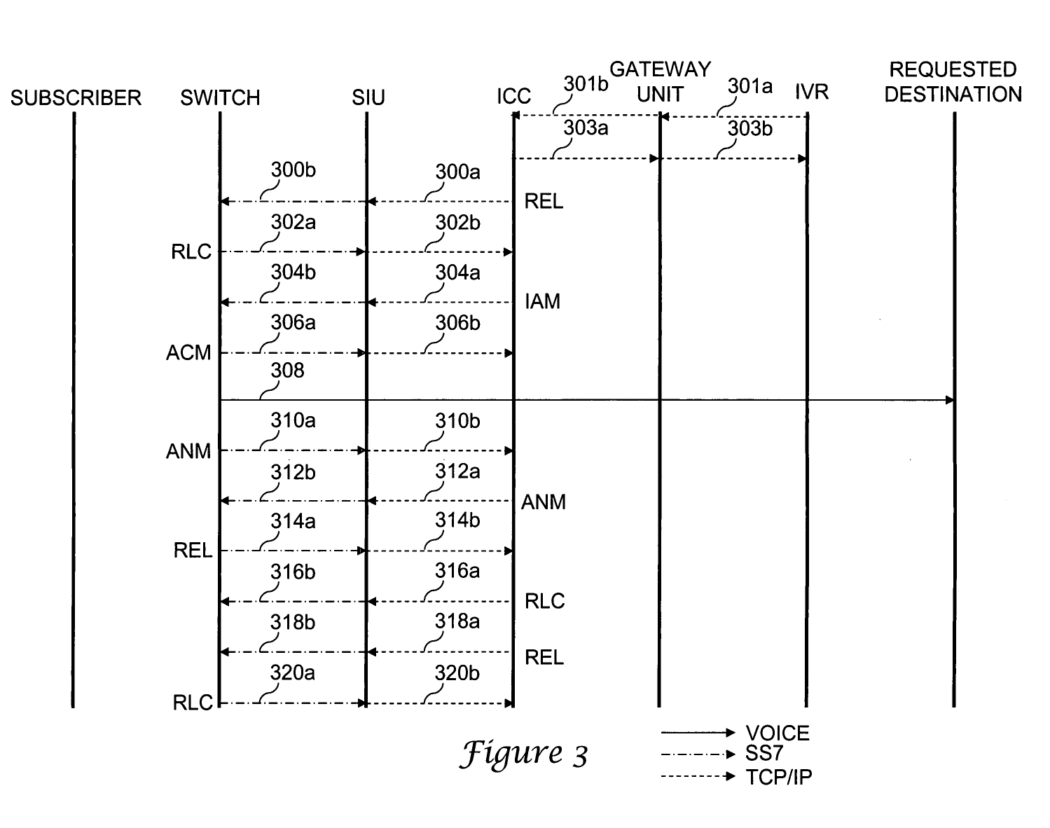

Assuming that primary IVR unit 133a plays an audio announcement 222 offering automatic call completion services, the subscriber has the option to return calling station 102 on-hook and dial the telephone number provided within audio announcement 222 or to request automatic call completion to the requested telephone number, for example, by dialing a specified digit (e.g., ‘1’) or merely remaining off-hook. If the subscriber hangs up, the DA call is terminated in a conventional manner. If, however, the subscriber requests automatic call completion (e.g., by dialing ‘1’ or remaining off-hook), the call may be completed automatically in accordance with FIG. 3.

With reference now to FIG. 3, there is illustrated time-space diagram of an exemplary method of automatic call completion in accordance with the present invention. In response to the subscriber requesting call completion, primary IVR unit 133a sends an IP transfer request message 301a, 301b to ICC 124 via gateway unit 126. ICC 124 replies to transfer request message 301b by transmitting an IP transfer complete message 303a, 303b to primary IVR unit 133a via gateway unit 126. In addition, ICC 124 sends an ISUP IP release (REL) message 300a indicating a normal release to SIU 122. SIU 122 converts the REL message 300a into an SS7 REL message 300b and transmits REL message 300b to serving switch 110a. Upon receiving the REL message 300b, serving switch 110a disconnects the trunk from operator center 132a, sets the trunk state to idle, and transmits an ISUP SS7 release complete (RLC) message 302a to SIU 122 to acknowledge the release of the remote end of the trunk circuit. SIU 122 converts RLC message 302a into IP RLC message 302b and transmits RLC message 302b to ICC 124.

In response to receipt of RLC message 302b, ICC 124 instructs serving switch 110a to reserve a trunk circuit for the call completion and connect the subscriber to called station 104 by transmitting an IP IAM 304a containing the ANI of called station 104 to SIU 122. In response to receipt of IAM 304a, SIU 122 converts IAM 304a into an SS7 IAM 304b and forwards IAM 304b to serving switch 110a. In response to receipt of IAM 304b, serving switch 110a rings called station 104 and transmits an SS7 ACM 306a to SIU 122 to indicate that a trunk circuit has been reserved for the call completion. SIU 122 converts SS7 ACM 306a into an IP ACM 306b and sends ACM 306b to ICC 124.

As indicated at reference numeral 308, when called station 104 goes off-hook, serving switch 110a establishes a voice connection of the original DA call with called station 104 utilizing the ANI received from ICC 124. In addition, serving switch 110a terminates the ringing tone and transmits to SIU 122 an ISUP answer message (ANM) 310a signifying completion of the call. SIU 122 converts the SS7 ANM 310a from SS7 to IP and transmits IP ANM 310b to ICC 124. ICC 124 acknowledges ANM 310b with an IP ANM 312a, which SIU 122 converts to SS7 ANM 312b and transmits to serving switch 110a. At this point, calling station 102 and the called station 104 have a voice connection over PSTN 106.

Once the calling station 102 or the called station 104 hang up, serving switch 110a sends an ISUP SS7 REL message 314a to release the trunk circuit on ISUP loopback 112a. SIU 122 converts REL message 314a to IP and routes IP REL message 314b to ICC 124. Upon receiving REL message 314b, ICC 124 disconnects the trunk circuit, sets the trunk state to idle, and transmits an ISUP RLC message 316a to acknowledge the release of the trunk circuit. The trunk circuit at serving switch 110a is similarly disconnected through the exchange of a REL message 318a, 318b transmitted by ICC 124 and a RLC message 320a, 320b transmitted by serving switch 110a.

As noted above, it may be desirable to provide directory assistance and call completion services from the backup operator center 132b and backup IVR unit 133b supported by backup directory assistance switch 130b, for example, due to high call volumes or due to the unavailability and/or failure of primary directory assistance switch 130a, primary operator center 132a and/or primary IVR unit 133a. In such cases, the call flow is identical to that depicted in FIGS. 2 and 3, except that ICC 124 instructs serving switch 110a to reserve a trunk circuit for the DA call and connect the DA call to backup operator center 132b over PSTN 140, for example, by Direct Inward Dial (DID) or 8XX access, by transmitting an IP IAM (corresponding to IAM 206a) containing the ANI of backup operator center 132b. The use of a relatively inexpensive switched network, such as PSTN 140 rather than expensive dedicated T1 trunks 134a, 134b makes the provision of telephony services from backup directory assistance switch 130b feasible even in the presence of potentially low call volumes. It will further be appreciated that in alternative embodiments of the present invention, primary directory assistance switch 130a may be eliminated all together, and all directory assistance and call completion services may be provided utilizing directory assistance switch(es) 130b coupled to serving switches 110 by one or more non-dedicated (e.g., switched) networks (e.g., PSTN 140).

As has been described, the present invention provides an improved method, apparatus and system for providing telephony services, such as directory assistance and call completion. In accordance with the present invention, ISUP trunk signaling by the serving switch controls the setup, connection, and release of calls between parties on the SS7 network. In this manner, the provision of telephony services is automated from the serving switch, reducing costs and improving the speed of service delivery. The release link call completion provided by the present invention is independent of the manufacturer-specific protocols and characteristics of the serving and directory assistance switches as well as the transport utilized to communicate between the two. Consequently, interoperability is enhanced.

While the invention has been particularly shown as described with reference to a preferred embodiment, it will be understood by those skilled in the art that various changes in form and detail may be made therein without departing from the spirit and scope of the invention. For example, although aspects of the present invention have been described with respect to an exemplary communication network including various devices, such as calling and called stations, switches, gateway units, SIUs, ICCs, operator centers, etc., it will be appreciated that some or all of these devices may be implemented by program code executing on a general purpose or special purpose data processing system. It should further be understood that the present invention may alternatively be implemented as a program product containing program code that causes the functions of the present invention to be performed. Program code defining the functions of the present invention can be delivered to a data processing system via a variety of signal-bearing media, which include, without limitation, non-rewritable storage media (e.g., CD-ROM), rewritable storage media (e.g., a floppy diskette or hard disk drive), and communication media, such as digital and analog networks. It should be understood, therefore, that such signal-bearing media, when carrying or encoding program code that directs the functions of the present invention, represent alternative embodiments of the present invention.

What is claimed is:

1. A method of providing telephony services in a communication network, said method comprising:
at a serving switch, receiving a directory assistance call;
in response to receipt of the directory assistance call, the serving switch signaling, via an out-of-band signaling link, to initiate reservation of a call path for the directory assistance call in a telephony network, said call path including a circuit loop at said serving switch; and
in response to reservation of the call path, the serving switch establishing a voice connection via the reserved call path in the telephony network to permit provision of directory assistance services.

2. The method of claim 1, wherein:
said out-of-band signaling link comprises a digital signaling link of a signaling system #7 (SS7) network; and
said signaling comprises transmitting a signaling message on said digital signaling link of said SS7 network.

3. The method of claim 1, wherein:
said circuit loop is an integrated services digital network user part (ISUP) loopback; and
said step of signaling comprises transmitting an ISUP initial address message (IAM).

4. The method of claim 1, wherein:
said receiving comprises receiving said directory assistance call from a first station in the communication network; and
said method further comprises said serving switch receiving over the voice connection an audible indication of a telephone number of a second station in the communication network and transmitting the audible indication to the first station.

5. The method of claim 1, wherein signaling to initiate reservation of a call path comprises signaling to initiate reservation of a call path between said serving switch and a directory assistance switch.

6. The method of claim 1, and further comprising:
said receiving comprises receiving said directory assistance call from a first station in the communication network;
said serving switch receiving, via out-of-band signaling, a digital message indicating a telephone number of a second station in the communication network;
said serving switch releasing a circuit in said circuit loop utilized to permit provision of directory assistance services; and
said serving switch establishing a voice connection of said directory assistance call to said second station utilizing said telephone number received in said digital message.

7. A program product, comprising:
a signal-bearing medium including program code that causes a serving switch in a communication network to:
in response to receipt of a directory assistance call, transmit a signal, via an out-of-band signaling link, to initiate reservation of a call path for the directory assistance call in a telephony network, said call path including a circuit loop at said serving switch; and
in response to reservation of the call path, establish a voice connection via the reserved call path in the telephony network to permit provision of directory assistance services.

8. The program product of claim 7, wherein said out-of-band signaling link comprises a digital signaling link of a signaling system #7 (SS7) network.

9. The program product of claim 7, wherein:
said circuit loop is an integrated services digital network user part (ISUP) loopback; and
said signal comprises an ISUP initial address message (IAM).

10. The program product of claim 7, wherein:
said directory assistance call is received from a first station in the communication network; and
said program code further causes said serving switch to receive over the voice connection an audible indication of a telephone number of a second station in the communication network and transmitting the audible indication to the first station.

11. The program product of claim 7, wherein said signal initiates reservation of a call path between said serving switch and a directory assistance switch.

12. The program product of claim 7, wherein:
said directory assistance call is received from a first station in the communication network; and
said program code causes said serving switch, responsive to receiving via out-of-band signaling a digital message indicating a telephone number of a second station in the communication network, to release a circuit in said circuit loop utilized to permit provision of directory assistance services and to establish a voice connection of said directory assistance call to said second station utilizing said telephone number received in said digital message.

13. A system, comprising:
a serving switch for a telephony network, said serving switch having a plurality of trunk connections; and
a circuit loop connecting said first and second trunk connections among said plurality of trunk connections;
wherein said serving switch is configured, responsive to receipt of a directory assistance call, to transmit a signal, via an out-of-band signaling link, to initiate reservation of a call path for the directory assistance call in a telephony network, said call path including the circuit loop; and
wherein said serving switch is further configured, responsive to reservation of the call path, to establish a voice connection via the reserved call path in the telephony network to permit provision of directory assistance services.

14. The system of claim 13, wherein:
said out-of-band signaling link comprise a digital signaling link of a signaling system #7 (SS7) network; and
said serving switch is configured to transmit a digital signaling message via said SS7 network to initiate reservation of said call path.

15. The system of claim 13, wherein:
said circuit loop is an integrated services digital network user part (ISUP) loopback; and
said signal comprises an ISUP initial address message (IAM).

16. The system of claim 13, wherein:
said directory assistance call is received from a first station coupled to said serving switch; and
said serving switch is further configured to receive over the voice connection an audible indication of a telephone number of a second station in the communication network and transmit the audible indication to the first station.

17. The system of claim 13, wherein said signal initiates reservation of a call path between said serving switch and a directory assistance switch.

18. The system of claim 13, wherein:
said directory assistance call is received from a first station coupled to said serving switch; and
said serving switch, responsive to receiving via out-of-band signaling a digital message indicating a telephone number of a second station in the communication network, releases a circuit in said circuit loop utilized to permit provision of directory assistance services and establishes a voice connection of said directory assistance call to said second station utilizing said telephone number received in said digital message.
